(19) United States
(12) Patent Application Publication
(10) Pub. No.: US 2015/0097100 A1
(43) Pub. Date: Apr. 9, 2015

(54) APPARATUS FOR SUSPENDING FIXTURES, SAID APPARATUS INCLUDING A RESILIENT PLASTIC TOP HAT PORTION

(71) Applicant: JOE LIN, MISSOURI CITY, TX (US)

(72) Inventor: JOE LIN, MISSOURI CITY, TX (US)

(21) Appl. No.: 14/046,780

(22) Filed: Oct. 4, 2013

(51) Int. Cl. F16B 19/14; F16M 13/02

(52) U.S. Cl. CPC F16B 19/14; F16M 13/027
USPC 248/546; 248/216.1

(57) ABSTRACT

A bracket having a flange defining a through hole; a fastener having a pointed end, the pointed end being dimensioned to pass through the through hole, the other end being dimensioned to not pass through the through hole; a resilient plastic top hat having a cylindrical portion and a flange portion, the cylindrical portion being dimensioned to fit through the through hole and the flange portion being dimensioned to not fit through the through hole, the cylindrical portion being dimensioned to receive and elastically embrace a portion of the fastener, the flange portion of the resilient plastic top hat being located at the first side of the bracket flange and the fastener extending through the through hole into the cylindrical portion with the other end of the fastener being located at the other side.

### CROSS-REFERENCE TO RELATED APPLICATIONS

This application is related to U.S. patent application Ser. No. 13/567,230 filed Aug. 6, 2012 and U.S. patent application Ser. No. 13/162,783 filed Jun. 17, 2011 which are continuations-in-part of U.S. patent application Ser. No. 12/785,674 filed May 24, 2010, which is a continuation-in-part of U.S. patent application Ser. No. 12/704,706 filed Feb. 12, 2010, now U.S. Pat. No. 8,397,969, the complete disclosures of which are hereby incorporated by reference herein.

### BACKGROUND OF THE INVENTION

1. Field of the Invention

This invention relates broadly to apparatus for suspending fixtures. More particularly, this invention relates to apparatus which include a bracket, a fastener, and a top hat which holds the fastener to the bracket prior to installation.

2. State of the Art

The incorporated applications and issued patent relate broadly to explosively driven fasteners and particularly to an apparatus for installing explosively driven fasteners and fasteners having explosive loads for use therewith. The fasteners disclosed are used in conjunction with apparatus for suspending fixtures including a bracket and, in some embodiments, a length of wire (typically six to eight feet long). Such apparatus are disclosed generally in U.S. Pat. Nos. 5,178,503 and 4,736,923. Improved such apparatus are disclosed in U.S. Pat. Nos. 6,669,158; 7,025,317; 7,341,232; and 8,047,496, the complete disclosures of which are hereby incorporated by reference herein.

The assembly of fasteners and bracket for suspending fixtures often includes a metal “top hat” which embraces the fastener and prevents it from being separated from the bracket. Occasionally a fastener will misfire, i.e. hit the surface without penetrating it. This causes the fastener to bend and deform both the fastener and the top hat. At this point, the fastener, the bracket, and the length of wire attached to the bracket are useless and are discarded.

U.S. Pat. No. 8,397,969 (Apparatus for Installing Explosively Driven Fasteners and Fasteners for Use Therewith) discloses fasteners with a self-contained explosive load. See, FIGS. 8-11 and accompanying description thereof in the '969 patent. Occasionally, the explosive load will fail to fire. When the fastener is attached to a metal top hat, it is virtually impossible to remove the fastener from the bracket so that the bracket and attached wire might be reclaimed. Thus, the entire assembly is discarded.

### SUMMARY OF THE INVENTION

The disclosed invention includes a bracket, said bracket having at least one flange, said at least one flange defining a first through hole; a fastener having a first pointed end and a second end, said first pointed end being dimensioned to pass through said first through hole, said second end being dimensioned to not pass through said first through hole; a resilient plastic top hat, said top hat having a cylindrical portion with first and second ends and a flange portion at said second end of said cylindrical portion, said first end of said cylindrical portion being dimensioned to fit through said first through hole and said flange portion being dimensioned to not fit through said first through hole, said cylindrical portion being dimensioned to receive and elastically embrace a portion of said fastener; said at least one flange having a first side and a second side, said flange portion of said resilient plastic top hat being located on said first side and said fastener extending through said first through hole into said cylindrical portion with said second end of said fastener being located on said second side.

### BRIEF DESCRIPTION OF THE DRAWINGS

FIG. 1 is a side elevation view of a prior art explosively driven fastener according to co-owned U.S. Pat. No. 8,397,969;

FIG. 2 is a broken side elevational view of the fastener of FIG. 1 coupled to a bracket and a length of suspension wire as shown in co-owned U.S. Pat. No. 8,397,969 and coupled to a metal top hat;

FIG. 3 is a broken perspective view of the assembly of FIG. 2 being loaded into a prior art tool according to co-owned U.S. Pat. No. 8,397,969;

FIG. 4 is a broken perspective view of the assembly fully loaded into the tool;

FIG. 5 is a perspective view of the assembly of FIG. 4 attached to an extension pole held by a worker ready for firing the fastener into a high ceiling (not shown);

FIG. 6 is a broken perspective view of the assembly of FIG. 2 after a misfire;

FIG. 7 is a broken exploded perspective view of an assembly according to a first embodiment of the invention;

FIG. 8 is a broken perspective view of the assembly of FIG. 7 after assembly and a misfire;

FIG. 9 is a broken perspective view of an assembly according to a first embodiment of the invention being assembled;

FIG. 10 is a broken perspective view of the assembly of FIGS. 7 and 9 after assembly being loaded into a prior art tool according to co-owned U.S. Pat. No. 8,397,969;

FIG. 11 is a perspective view of the assembly of FIG. 10 attached to an extension pole held by a worker ready for firing the fastener into a high ceiling (not shown);

FIG. 12 is a perspective view of an assembly according to a second embodiment of the invention being assembled;

FIG. 13 is a perspective view of the assembly of FIG. 12 being loaded into a prior art tool according to co-owned U.S. Pat. No. 8,397,969 after it has been assembled;

FIG. 14 is a perspective view of the assembly of FIG. 13 attached to an extension pole held by a worker ready for firing the fastener into a high ceiling (not shown);

FIG. 15 is a perspective view of an assembly according to a third embodiment of the invention being assembled;

FIG. 16 is a perspective view of the assembly of FIG. 15 with an attached hanger wire being loaded into a prior art tool according to co-owned U.S. Pat. No. 8,397,969 after it has been assembled; and

FIG. 17 is a perspective view of the assembly of FIG. 16 attached to an extension pole held by a worker ready for firing the fastener into a high ceiling (not shown).

### DETAILED DESCRIPTION

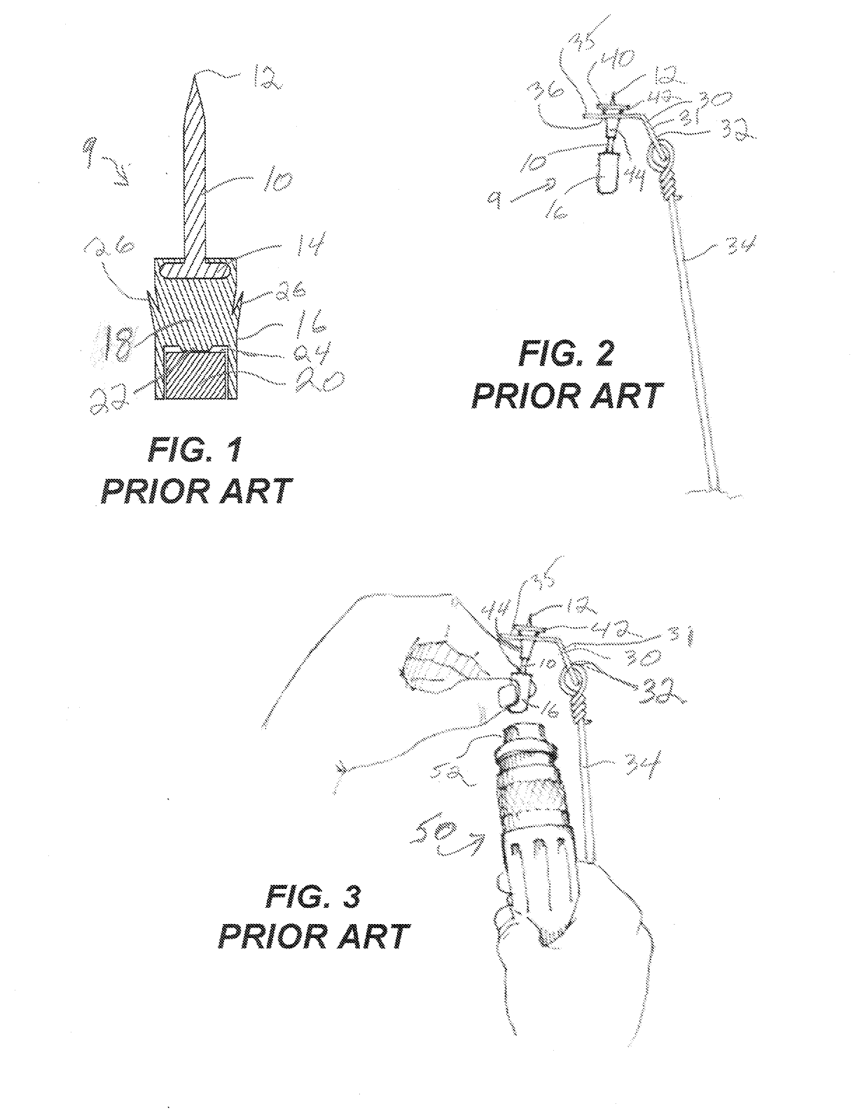

Turning now to FIG. 1, a prior art explosive fastener assembly 9 according to co-owned U.S. Pat. No. 8,397,969 includes a fastener, e.g. a nail 10 having a pointed distal end 12 and a proximal nail head 14. The nail head 14 is mounted inside a plastic cap 16 containing a buffer 18 and a nitrocellulose load 20. Preferably, a spacer 22 is arranged between the buffer 18 and the load 20 creating an air space 24 between the buffer and the load. The plastic cap 16 also tends to guide the nail during penetration allowing the nail to penetrate more deeply into hard surfaces. The plastic cap is preferably provided with outwardly extending flutes or wings 26. The wings help hold the fastener in the tool (described below) until the fastener is fired.

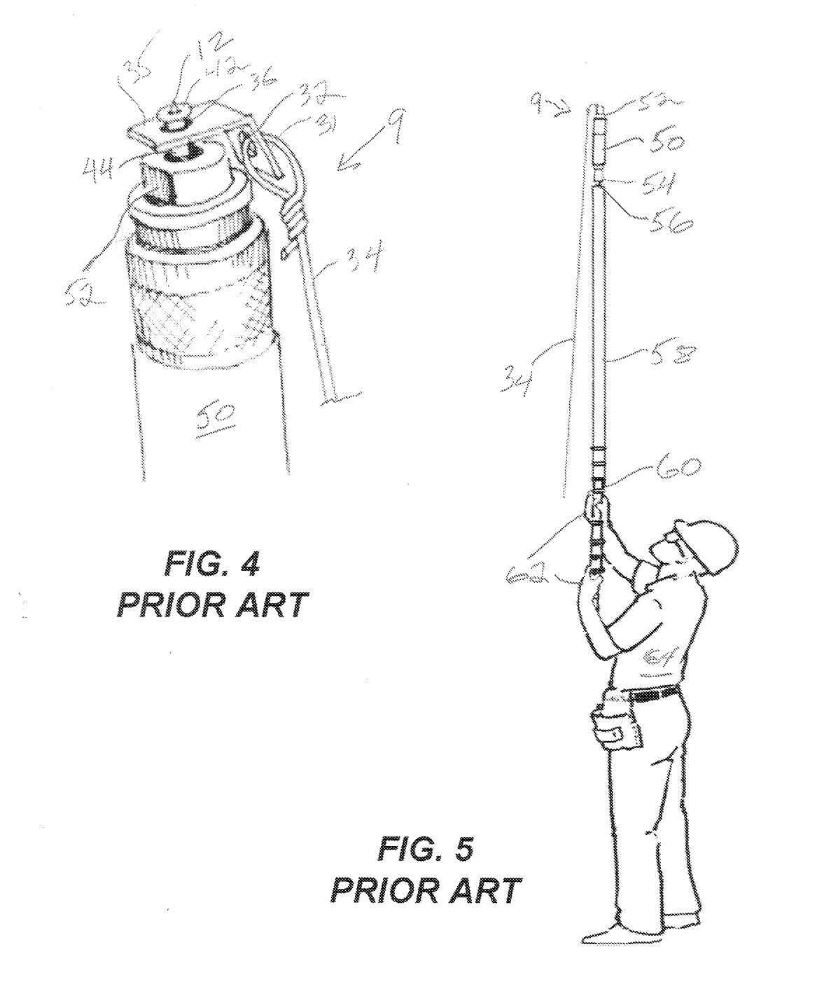

According to the example provided in FIGS. 2-5, the fastener 9 is used in conjunction with a bracket 30 having two flanges 31, 35 having respective holes 32, 36. One hole 32 of the bracket 30 is coupled to a length of suspension wire 34 and the other hole 36 of the bracket 30 is adapted to receive the nail 10 and a metal top hat 40 as seen best in FIGS. 2 and 3. The top hat is a unitary piece having a generally cylindrical shape with an upper annular flange 42 and a lower extending cylinder 44. When assembled as shown in FIGS. 2 and 3, the cylinder 44 is tightly press fit over the nail 10 with the annular flange 42 on the upper side of the bracket 30 and the nail 10 extending through the hole 36 of the bracket 30. Those skilled in the art will appreciate that the top hat 40 prevents the nail 10 from separating from the bracket 30. This is convenient because the workers will be installing several preassembled brackets with fasteners and wires during a single work session.

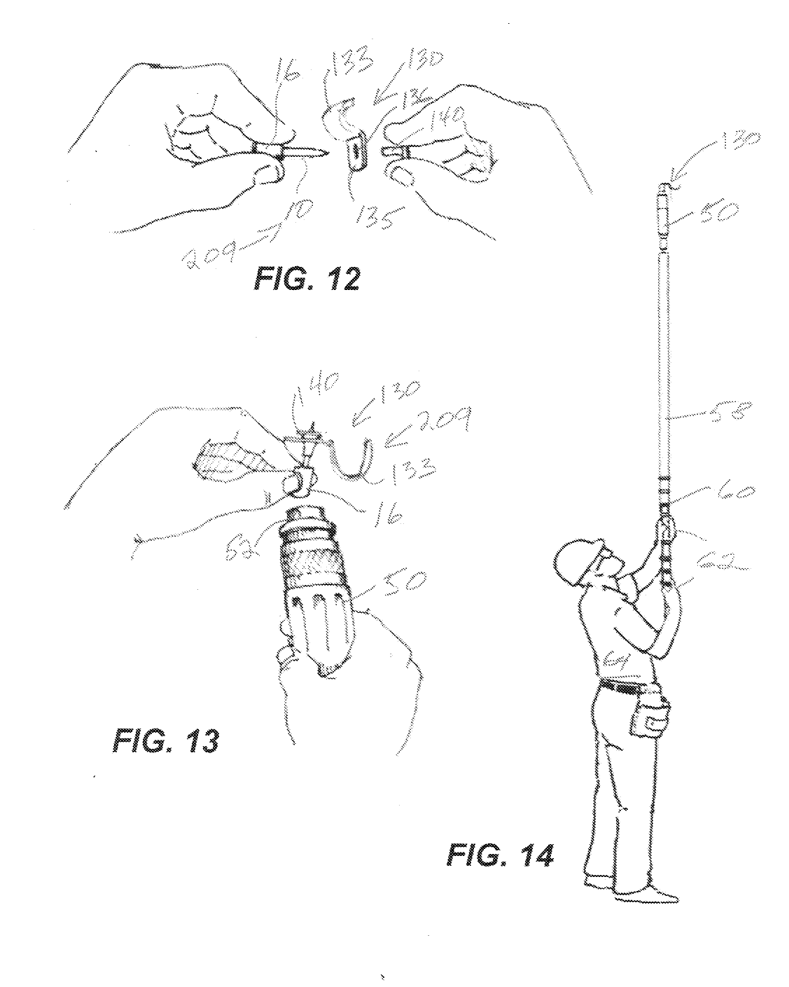

The assembly shown in FIG. 2 is designed to be used with a firing tool 50 as described in co-owned U.S. Pat. No. 8,397,969 and shown here in FIGS. 3-5. The tool 50 has a muzzle 52 dimensioned to receive the cap 16 of the fastener assembly 9 and a proximal threaded end 54 for coupling to the threaded distal end 56 of an extension pole 58. The proximal end of the pole 58 is provided with hand grips 60 which can be gripped by the hands 62 of a worker 64 as shown in FIG. 5. In order to install the assembly 9, the worker 64 pushes up on the hand grips 60 thereby urging the tool 50 closer to the ceiling (not shown) until the load 20 in the plastic cap 16 explodes as shown and described in co-owned U.S. Pat. No. 8,397,969 with reference to FIGS. 12-17.

### Problem Part 1

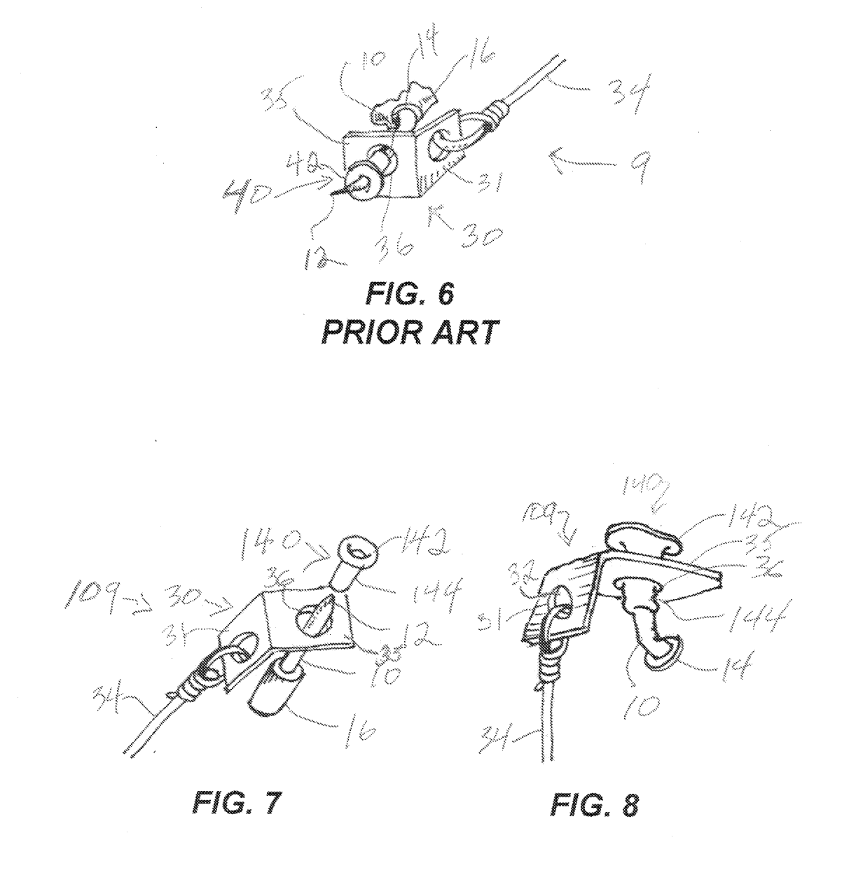

FIG. 6 shows the assembly 9 after a misfire. As seen in FIG. 6, the nail 10 including the pointed distal end 12 is bent and/or otherwise deformed. As shown in FIG. 6, the load contained in the plastic cap 16 has exploded and the cap 16 is therefore shown in fragment. The top hat 40 is (or may be) also deformed. As such, the nail head 14 and the annular flange 42 are fixed in place relative to each other on opposite sides of the bracket flange 35. There is no convenient way to separate the top hat 40 from the nail 10 so that they could be replaced. Thus, the entire assembly including the nail 10, the bracket 30, and the wire 34 must be discarded and replaced with a new assembly. this is particularly wasteful when, as shown, the wire 34 is pre-wound and coupled to the bracket in a manner that makes the bracket 30 and the wire 34 virtually inseparable.

### Solution Part 1

Referring now to FIG. 7, an assembly 109 according to a first embodiment of the invention includes prior art components: nail 10, bracket 30, and wire 34. The nail 10 has a pointed distal end 12 and a proximal nail head 14. The nail head 14 is mounted inside a plastic cap 16 containing a buffer 18 and a nitrocellulose load 20. Preferably, a spacer 22 is arranged between the buffer 18 and the load 20 creating an air space 24 between the buffer and the load. The plastic cap 16 also tends to guide the nail during penetration allowing the nail to penetrate more deeply into hard surfaces. The plastic cap is preferably provided with outwardly extending flutes or wings 26. The wings help hold the fastener in the tool (described below) until the fastener is fired. The fastener 9 is used in conjunction with a bracket 30 having two flanges 31, 35 having respective holes 32, 36. One hole 32 of the bracket 30 is coupled to a length of suspension wire 34 and the other hole 36 of the bracket 30 is adapted to receive the nail 10.

According to the first embodiment of the invention, a resilient plastic top hat 140 as seen best in FIGS. 2 and 8. The top hat 140 is a unitary piece having a generally cylindrical shape with an upper annular flange 142 and a lower extending cylinder 144. When assembled as shown in FIGS. 8 and 10, the cylinder 144 is snugly and elastically press fit over the nail 10 with the annular flange 142 on the upper side of the bracket flange 35 and the nail 10 extending through the hole 36 of the bracket 30 with the nail head and plastic cap 16 on the lower side of the bracket flange 35. Those skilled in the art will appreciate that the top hat 140 prevents the nail 10 from separating from the bracket 30.

FIG. 8 shows the assembly 109 after a misfire. It can be seen that the top hat 140 is deformed and the nail 10 is bent. However, since the top hat 140 is resilient and elastic, it can easily be separated from the nail 10. This may require some twisting and pulling, but it is a relatively simple and easy procedure. Once the nail 10 and top hat 140 are removed, the worker is left with a bracket 30 and attached wire 34 which is reusable by installing a new nail and a top hat.

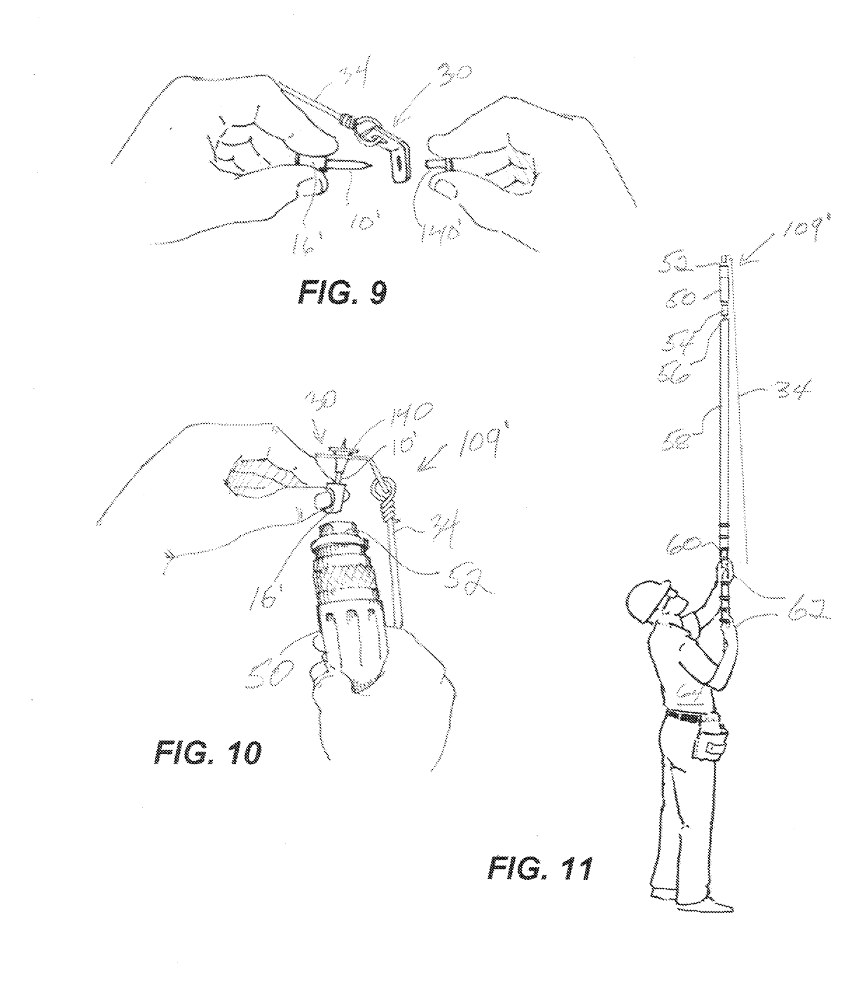

Installation of a new nail 10′ with load containing plastic cap 16′ is shown in FIG. 9. As illustrated, a new plastic top hat 140′ is being used. However, if the old top hat 140 is not severely damaged, it can be reused. Those skilled in the art will appreciate that after the nail is fired correctly into the concrete ceiling, the top hat no longer serves any function. It is not a structural component of the fastener assembly 109 after the assembly 109 is installed.

The a “refreshed assembly” 109′ with the new nail 10′, load 16′, top hat 140 or 140′ coupled to the bracket 30 and wire 34, the assembly can be loaded into the muzzle 52 of the tool 50 as shown in FIG. 10. The tool 50 is coupled by the proximal threaded end 54 thereof to the threaded distal end 56 of an extension pole 58. The proximal end of the pole 58 is provided with hand grips 60 which can be gripped by the hands 62 of a worker 64 as shown in FIG. 11. In order to install the assembly 109′, the worker 64 pushes up on the hand grips 60 thereby urging the tool 50 closer to the ceiling (not shown) until the load in the plastic cap 16′ explodes as described herein above.

### Alternative Embodiments

FIG. 12 illustrates the invention in conjunction with a second embodiment of a bracket 130. The bracket 130 includes a flange 135 with a hole 136 for receiving nail 10 and the plastic top hat 140. However, unlike the first embodiment which included a flange with a hole to which a long wire was coupled, in this embodiment, the bracket 130 includes curved flange 133 extending from the flat flange 135. The curved flange 133 is ideal for supporting conduits used in electrical and plumbing applications just to name a few.

The assembly 209 of the bracket 130, nail 10 with load containing cap 16 and plastic top hat 140 is inserted into the muzzle 52 of the tool 50 as shown in FIG. 13 prior to installation. The tool 50 is attached to an extension pole 58 as shown in FIG. 14. It is then arranged with the bracket 130 facing the ceiling (not shown) with a conduit (not shown) resting in the curved flange 133 of the bracket 130. The worker 64 pushes the pole 58 up as described above to install the bracket and secure the conduit against the ceiling.

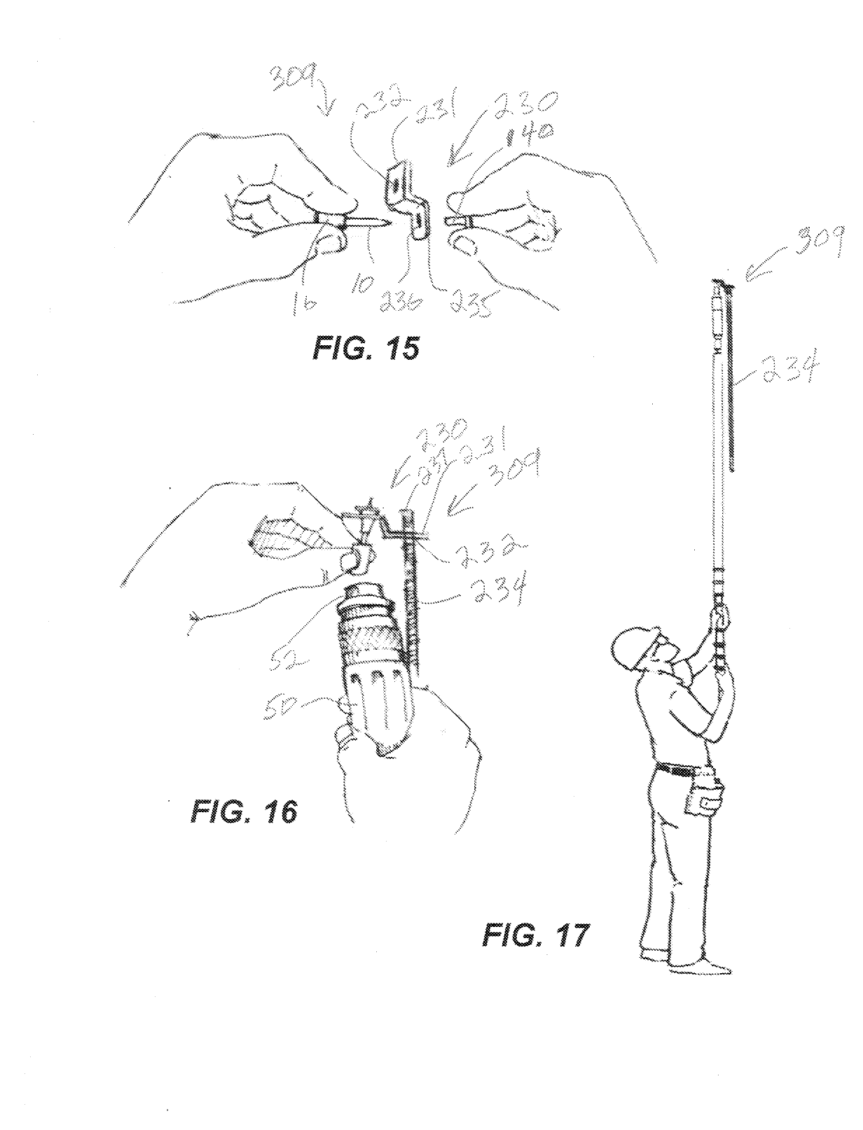

FIGS. 15-17 show a third embodiment which uses a bracket and wire assembly such as that shown in previously incorporated U.S. Pat. No. 6,669,158. Here the bracket 230 is substantially Z configured with two parallel but spaced apart flanges 231, 235. Both flanges are provided with respective through bores 232, 236. Through bore 236 is adapted to receive the nail 10 and the plastic top hat 140. Through bore 232 is adapted to receive a wire 234 having a deformed end 237 which prevents it from passing entirely through the bore 232.

The assembly 309 of the bracket 230, nail 10 with load containing cap 16 and plastic top hat 140 is inserted into the muzzle 52 of the tool 50 as shown in FIG. 16 prior to installation. The tool 50 is attached to an extension pole 58 as shown in FIG. 17. It is then arranged with the flange 235 of the bracket 230 facing the ceiling (not shown). The worker 64 pushes the pole 58 up as described above to install the bracket and secure the conduit against the ceiling.

It should be recognized that all of the embodiments described above are applicable to nails which do not carry self-contained loads but which are plain nails having a point and a nail head. These nails are typically fired by tools that contain some sort of propellant to hit the nail head hard enough to drive the nail into a concrete ceiling.

### Problem Part 2

The second problem solved by the invention involves the situation when a nail 10 having a cap 16 containing a load 20 fails to fire. That is, the tool 50 fires the firing pin correctly into the load 20 but the load does not ignite for whatever reason. The worker is left with an assembly that looks substantially the same as the one started with but the load is a “dud”. It is virtually impossible to remove the cap 16 containing the load 20 from the nail 10 and replace it with a new load containing cap. Therefore, the entire assembly is wasted and a new assembly must be loaded into the tool. That is the case with the prior art assemblies that use metal top hats.

### Solution Part 2

The solution to the second problem is nearly the same as the solution to the first problem. Here, however, neither the nail nor the plastic top hat are deformed. This makes it easier to replace the nail and likely use the same plastic top hat. The remainder of the solution to the second problem proceeds in the same manner as the first problem's solution.

There have been described and illustrated herein several embodiments of an APPARATUS FOR SUSPENDING FIXTURES, SAID APPARATUS INCLUDING A RESILIENT PLASTIC TOP HAT PORTION. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

What is claimed is:

1. An apparatus for suspending fixtures, said apparatus comprising:
a bracket, said bracket having at least one flange, said at least one flange defining a first through hole;
a fastener having a first pointed end and a second end, said first pointed end being dimensioned to pass through said first through hole, said second end being dimensioned to not pass through said first through hole;
a resilient plastic top hat, said top hat having a cylindrical portion with first and second ends and a flange portion at said second end of said cylindrical portion, said first end of said cylindrical portion being dimensioned to fit through said first through hole and said flange portion being dimensioned to not fit through said first through hole, said cylindrical portion being dimensioned to receive and elastically embrace a portion of said fastener;
said at least one flange having a first side and a second side, said flange portion of said resilient plastic top hat being located at said first side and said fastener extending through said first through hole into said cylindrical portion with said second end of said fastener being located at said second side.

2. An apparatus according to claim 1, further comprising:
a length of wire having a first end and a second end, wherein
said bracket has a second flange, said first end of said length of wire being coupled to said second flange.

3. An apparatus according to claim 2, wherein:
said second end of said fastener defines a nail head.

4. An apparatus according to claim 1, further comprising:
an explosive load coupled to said second end of said fastener.

5. An apparatus according to claim 2, further comprising:
an explosive load coupled to said second end of said fastener.

6. An apparatus according to claim 3, further comprising:
an explosive load coupled to said nail head.

7. A kit containing apparatus for suspending fixtures, said kit comprising:
a bracket, said bracket having at least one flange, said at least one flange defining a first through hole;
a plurality of fasteners, each having a first pointed end and a second end, said first pointed end being dimensioned to pass through said first through hole, said second end being dimensioned to not pass through said first through hole;
a resilient plastic top hat, said top hat having a cylindrical portion with first and second ends and a flange portion at said second end of said cylindrical portion, said first end of said cylindrical portion being dimensioned to fit through said first through hole and said flange portion being dimensioned to not fit through said first through hole, said cylindrical portion being dimensioned to receive and elastically embrace a portion of any one of said fastener;
said at least one flange having a first side and a second side, said flange portion of said resilient plastic top hat being located at said first side and said fastener extending through said first through hole into said cylindrical portion with said second end of said fastener being located at said second side.

8. A kit according to claim 7, wherein:
each of said fasteners includes an explosive load.

9. A lit according to claim 7, further comprising:
a plurality of resilient plastic top hats, each being substantially identical to said resilient plastic top hat.

10. A kit according to claim 7, further comprising:
a plurality of brackets, each being substantially identical to said bracket.

11. A kit for use with a bracket, said bracket having at least one flange, said at least one flange defining a first through hole, said kit comprising:
a plurality of fasteners, each having a first pointed end and a second end, said first pointed end being dimensioned to pass through said first through hole, said second end being dimensioned to not pass through said first through hole; and
a plurality of resilient plastic top hats, each top hat having a cylindrical portion with first and second ends and a flange portion at said second end of said cylindrical portion, said first end of said cylindrical portion being dimensioned to fit through said first through hole and said flange portion being dimensioned to not fit through said first through hole, said cylindrical portion being dimensioned to receive and elastically embrace a portion of any one of said fasteners.

12. A kit according to claim 11, wherein:
said second end of each of said fasteners defines a nail head.

13. A kit according to claim 11, further comprising:
an explosive load coupled to said second end of each of said fasteners.
